(19) United States
(12) Patent Application Publication
(10) Pub. No.: US 2019/0373072 A1
(43) Pub. Date: Dec. 5, 2019

(54) EVENT NOTIFICATION

(71) Applicant: Lenovo (Singapore) Pte. Ltd., Singapore (SG)

(72) Inventors: Russell Speight VanBlon, Raleigh, NC (US); Nathan J. Peterson, Oxford, NC (US); John Carl Mese, Cary, NC (US)

(21) Appl. No.: 15/993,175

(22) Filed: May 30, 2018

(51) Int. Cl. H04L 29/08; G06F 3/01

(52) U.S. Cl. CPC H04L 67/26; G06F 3/013

(57) ABSTRACT

One embodiment provides a method, including: receiving, at an information handling device, an indication to provide an event notification to a user; determining, using one or more sensors, an attentive state of the user; and providing, responsive to the determining, the event notification using an output type appropriate for the user's attentive state. Other aspects are described and claimed.

### BACKGROUND

Information handling devices (“devices”), for example smart phones, tablet devices, wearable devices, smart speakers, laptop and personal computers, and the like, may be capable of providing an event notification to a user. For example, a device may display a visual message alerting a user that a scheduled meeting is upcoming (e.g., a meeting is starting in 30 minutes, etc.). In another example, a device may provide an audible alert that a set timer has expired. In yet a further example, a wearable device (e.g., a smart watch, a fitness tracker, etc.) may vibrate or use another haptic effect to alert a user that a new text message or email communication has been received.

### BRIEF SUMMARY

In summary, one aspect provides a method, comprising: receiving, at an information handling device, an indication to provide an event notification to a user; determining, using one or more sensors, an attentive state of the user; and providing, responsive to the determining, the event notification using an output type applicable to the attentive state.

Another aspect provides an information handling device, comprising: one or more sensors; a processor; a memory device that stores instructions executable by the processor to: receive an indication to provide an event notification to a user; determine an attentive state of the user; and provide, responsive to the determining, the event notification using an output type applicable to the attentive state.

A further aspect provides a product, comprising: a storage device that stores code, the code being executable by a processor and comprising: code that receives an indication to provide an event notification to a user; code that determines an attentive state of the user; and code that provides, responsive to the determining, the event notification using an output type applicable to the attentive state.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of providing an event notification to a user.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Conventionally, a device will notify a user of an event (e.g., a newly received communication, a scheduled meeting, a timer expiration, etc.) using one or more default output settings (e.g., that are set by a manufacturer, adjusted by a user, etc.). For example, a user may silence their device so that all event notifications are communicated via a non-audible, visual notification on the device's display screen. As another example, notification settings may be application specific so that each application provides notifications using one or more preset output settings (e.g., Application A provides all event notifications associated with Application A using audible output, Application B provides all event notifications associated with Application B using a combination of visual output and haptic output, etc.).

Although many methods exist to notify a user of an event, these methods may not always effectively communicate the event notification to the user. A common reason for this issue is that a user's contextual situation is frequently changing. Stated differently, a user may not always be oriented or located in the optimal position to receive a notification provided using a particular output method. For example, a user may miss visual notifications if they are not looking at their display screen the moment the notification is provided. In another example, a user may miss haptic and/or audible notifications if they are too far away from their device. In yet a further example, the user's surrounding environment may be such that various default event notification methods may be compromised and made ineffective (e.g., a user may be in a very loud and crowded environment, a user may be in a very bright environment, etc.). As such, conventional methods are unable to ensure that a user will be apprised of the event notification.

Accordingly, an embodiment provides a method for dynamically identifying an output type through which a user may best be apprised of an event notification based upon their determined attentive state. In an embodiment, an indication to provide an event notification to a user may be received at a device. An embodiment may then determine an attentive state of the user (e.g., a user's gaze direction, a user's location, a user's proximity to a device, an activity a user is engaged in, etc.) and thereafter provide the event notification using an output type that best corresponds to the user's attentive state. Such a method may limit or eliminate the instances in which an event notification is missed by a user.

The illustrated example embodiments will be best understood by reference to the figures. The following description is intended only by way of example, and simply illustrates certain example embodiments.

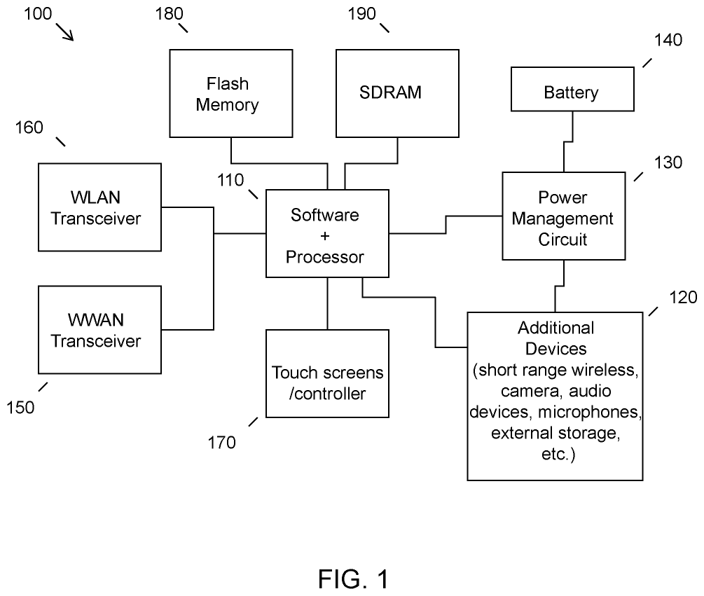

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, a thermal sensor, etc. System 100 often includes one or more touch screens 170 for data input and display/rendering. System 100 also typically includes various memory devices, for example flash memory 180 and SDRAM 190.

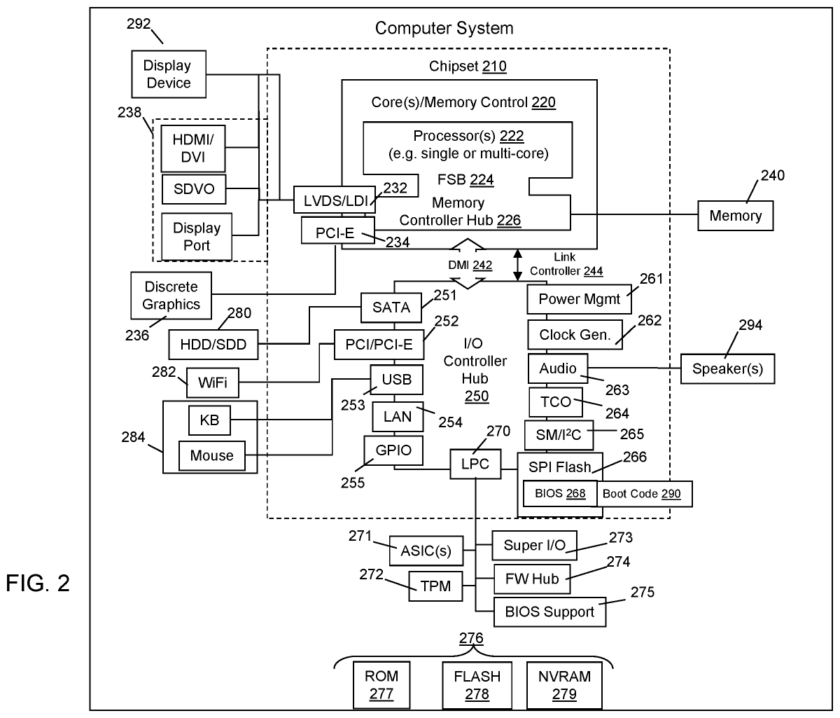

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as smart phones, tablets, smart speakers, smart appliances, personal computer devices generally, and/or electronic devices that are capable of communicating with other devices and/or are capable of providing output notifications to a user. For example, the circuitry outlined in FIG. 1 may be implemented in a tablet or smart phone embodiment, whereas the circuitry outlined in FIG. 2 may be implemented in a laptop embodiment.

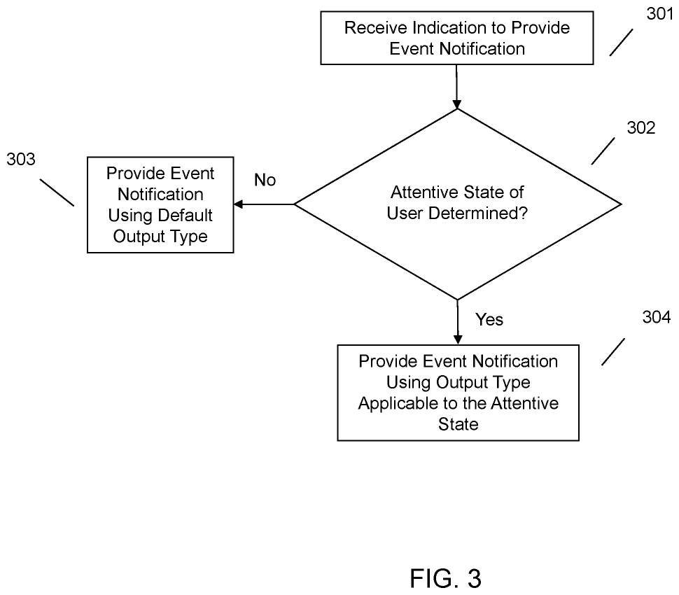

Referring now to FIG. 3, an embodiment may provide an event notification to a user using an output type that is most applicable to the user's attentive state. At 301, an embodiment may receive, at a device, an indication to provide an event notification to a user. In an embodiment, the event notification may be virtually any type of notification that a device can provide to a user. For example, the event notification may be a notification of an incoming communication (e.g., incoming call, received text message, received email, etc.), a social media notification, a meeting reminder, a timer expiration notification, an alarm, etc.

In an embodiment, the event notification may be provided using one or more output types. As used herein, an output type may refer to one or more output devices integrally or operatively coupled to the device that may provide the event notification such as, but not limited to, display screens (e.g., to provide visual notifications, etc.), speakers/headphones (e.g., to provide audible notifications, etc.), haptic devices (e.g., to provide vibrational notification, etc.), and the like. Additionally or alternatively, an output type may refer to output provided by one or more of the aforementioned output devices integrally or operatively coupled to another device in communication with the first device (e.g., another smart phone, tablet, smart speaker, wearable device, laptop or personal computer, etc.) via a wireless connection (e.g., using a BLUETOOTH connection, near field communication (NFC), other wireless connection techniques, etc.), a wired connection (e.g., the device is coupled to another device or source, etc.), through a connected data storage system (e.g., via cloud storage, remote storage, local storage, network storage, etc.), and the like.

At 302, an embodiment may determine an attentive state of the user. As used herein, the attentive state of the user may refer to a user's ability to receive and/or comprehend the event notification at a particular moment in time. For example, the attentive state may refer to a location of the user with respect to one or more devices, a gaze direction of the user, an activity engaged in by the user, a positional orientation of the user's device, etc. In an embodiment, the attentive state may be determined using one or more sensors integrally or operatively coupled to one or more devices such as, but not limited to, static or dynamic cameras, microphones, gyroscopes, accelerometers, positional/location sensors (e.g., Global Positioning System (GPS) receivers, etc.), and the like. In an embodiment, the attentive state may be determined prior to provision of the event notification.

The instant paragraph includes numerous non-limiting examples of attentive state determination. An embodiment may determine whether a user is gazing at a display screen of their device at a time when the indication to provide an event notification is received. This determination may be achieved, for example, by using one or more cameras to capture an image of the user from which their gaze direction may be determined. Additionally or alternatively, the determination may also be realized by identifying whether a user is, or recently has (e.g., within the past 2 seconds, etc.), actively interacting with the device (e.g., providing touch inputs to a touch surface of the device, etc.). In a similar vein, an embodiment may determine whether a display screen of the device is within a user's field of view when the indication is received. In yet another embodiment, a user's distance away from their device may be determined (e.g., by using one or more cameras, motion sensors, etc.). An embodiment may also determine a user's position within a predetermined area. For example, an embodiment may determine a user's position in their home by receiving data obtained from other devices (e.g., motion data, image data, audible data, etc.). Using this data, an embodiment may be able to identify which room a user is in and/or which devices, if any, are proximate to the user. In yet a further embodiment, a positional orientation of the device may be determined. For example, an embodiment may use one or more sensors (e.g., cameras, gyroscopes, accelerometers, etc.) to determine whether the device is facing up or down, is in an enclosed location (e.g., a user's pocket, on a user's wrist, etc.), is moving, and the like.

In an embodiment, data obtained from other sources may also be used to determine a user's attentive state. For example, a user's location and/or an activity engaged in the by the user may be identified by accessing a user's calendar entries, social media data, communication data, and the like. For example, an embodiment may be able to identify that a user is in a loud environment, such as a concert or a sporting event, by accessing a user's calendar entries.

Responsive to determining, at 302, the attentive state of the user, an embodiment may provide, at 304, the event notification using an output type that is applicable to the user's attentive state. The following paragraphs include numerous non-limiting examples of output types that conform to a user's attentive state.

In an embodiment, responsive to determining that the user's gaze is not focused on a display screen of the device, an embodiment may provide the event notification using at least one other output device other than the display device (e.g., an audible notification may be provided using one or more speakers of the device or another device, etc.). In another embodiment, responsive to determining that the device is within a user's field of view but is oriented face-down on a surface, an embodiment may provide the event notification using audible output from the device or visual output on another device in the user's field of view (e.g., another device a user is currently interacting with, etc.).

In an embodiment, responsive to determining that the device is in a position or orientation where a user may not see, hear, or feel an event notification (e.g., if the device is in a user's pocket, etc.) an embodiment may detect if a user is using another device (e.g., wearing a smart watch, etc.) and provide the event notification on that device. Similarly, in an embodiment, responsive to determining that the user is engaged in an activity or is in an environment in which they would have difficulty seeing, hearing, or feeling a visual, audible, or haptic notification, an embodiment may provide the event notification using another device (e.g., a wearable device on a user's wrist, etc.).

In an embodiment, responsive to determining that a user's location with respect to their device is greater than a predetermined distance, an embodiment may increase an effect of the output device (e.g., increase the audible output volume level, etc.). The magnitude of the increased effect may be based on the distance away from the device a user is determined to be (e.g., the greater the distance away a user is determined to be, the greater the audible output volume level becomes, etc.). Additionally or alternatively, responsive to determining that a user's location with respect to their device is greater than a predetermined distance, an embodiment may provide the event notification using another device proximate to the user's determined location. For example, responsive to identifying that a user is in another room from the device, an embodiment may detect that another device (e.g., a smart speaker, etc.) is in the same room as the user and provide an instruction to that other device to provide the event notification to the user.

In an embodiment, a user's device may comprise a number of default output settings (e.g., predetermined output types for each application, explicit output types as set by a user, etc.). Responsive to determining that the user cannot receive the event notification using a default output type, an embodiment may provide the event notification using another output type that is applicable to the user's attentive state. For example, a device may comprise default output settings for all communications received by the device. The default output settings may provide a notification that a communication was received by providing a visual message and/or an audible sound. Responsive to determining that a user is in another room, and therefore may not hear or see the notification, an embodiment may provide the notification using another device (e.g., another device in the same location as the user, etc.).

Responsive to not determining, at 302, an attentive state of the user, an embodiment may provide, at 303, the event notification using default output settings. Alternatively, if an attentive state of the user cannot be determined (e.g., the user's location cannot be identified, etc.) an embodiment may utilize all capable devices in a predetermined area (e.g., the user's home, office, etc.) to reach the user (e.g., via an audible notification, visual notification, etc.) one-by-one or simultaneously and wait to receive acknowledgement input from the user (e.g., provided to an input device integrally or operatively coupled to one or more devices such as a microphone, touch pad, hard or soft keyboard, etc.). Responsive to receiving the acknowledgement input, an embodiment may provide the event notification using the acknowledgement input recipient device or a proximate device. For example, a user may leave their smartphone in a room upstairs and thereafter walk downstairs. If a user's location is unable to be determined, all connected devices in the home may output an audible message such as “User A please respond”. Responsive to receiving, at a smart speaker in the living room for example, a response from the user such as “I'm here” (e.g., “I'm here”, etc.), the living room smart speaker may provide the notification to the user.

The various embodiments described herein thus represent a technical improvement to conventional event notification techniques. Using the techniques described herein, an embodiment may receive an indication to provide an event notification to a user. An embodiment may then determine an attentive state of the user and thereafter provide the event notification using an output type that is appropriate and applicable to the user's attentive state. Such techniques may ensure that a user receives event notifications via an output type that is appropriate for the user's contextual situation.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, comprising:
receiving, at an information handling device, an indication to provide an event notification to a user;
determining, using one or more sensors, an attentive state of the user;
identifying, using the one or more sensors, a positional orientation of the information handling device;
determining, using a processor, that the event notification cannot be communicated to the user from the information handling device based on the attentive state and the positional orientation; and
providing, responsive to the determining, the event notification using another device comprising output capabilities compatible with the attentive state.

2. The method of claim 1, wherein the attentive state is associated with a user's awareness of the event notification.

3. The method of claim 1, wherein the output type is associated with at least one output device operatively coupled to the information handling device or at least one other device.

4. The method of claim 1, wherein the determining comprises determining the attentive state using data obtained from at least one other device.

5. The method of claim 1, wherein the determining the attentive state comprises determining a location of the user with respect to the information handling device.

6. The method of claim 5, further comprising identifying, responsive to determining that the location of the user with respect to the information handling device is greater than a predetermined distance, at least one other device proximate to the location and providing an instruction to the at least one other device to provide the event notification.

7. The method of claim 1, wherein the determining the attentive state comprises determining a gaze direction of the user.

8. (canceled)

9. The method of claim 1, wherein the determining the attentive state comprises determining an activity engaged in by the user.

10. The method of claim 1, further comprising determining, based on the attentive state, that the user cannot receive the event notification using a default output type and wherein the providing comprises providing, responsive to determining that the user cannot receive the event notification using the default output type, the event notification using the output type.

11. An information handling device, comprising:
one or more sensors;
a processor;
a memory device that stores instructions executable by the processor to:
receive an indication to provide an event notification to a user;
determine an attentive state of the user;
identify, using the one or more sensors, a positional orientation of the information handling device;
determining, using a processor, that the event notification cannot be communicated to the user from the information handling device based on the attentive state and the positional orientation; and
provide, responsive to the determining, the event notification using another device comprising output capabilities compatible with the attentive state.

12. The information handling device of claim 11, wherein the attentive state is associated with a user's awareness of the event notification.

13. The information handling device of claim 11, wherein the instructions executable by the processor to determine comprise instructions executable by the processor to determine the attentive state using data obtained from at least one other device.

14. The information handling device of claim 11, wherein the instructions executable by the processor to determine the attentive state comprise instructions executable by the processor to determine a location of the user with respect to the information handling device.

15. The information handling device of claim 14, wherein the instructions are further executable by the processor to identify, responsive to determining that the location of the user with respect to the information handling device is greater than a predetermined distance, at least one other device proximate to the location and provide an instruction to the at least one other device to provide the event notification.

16. The information handling device of claim 11, wherein the instructions executable by the processor to determine the attentive state comprise instructions executable by the processor to determine a gaze direction of the user.

17. (canceled)

18. The information handling device of claim 11, wherein the instructions executable by the processor to determine the attentive state comprise instructions executable by the processor to determine an activity engaged in by the user.

19. The information handling device of claim 11, wherein the instructions are further executable by the processor to determine, based on the attentive state, that the user cannot receive the event notification using a default output type and wherein the instructions executable by the processor to provide comprise instructions executable by the processor to provide the event notification using the output type responsive to determining that the user cannot receive the event notification using the default output type.

20. A product, comprising:
a storage device that stores code, the code being executable by a processor and comprising:
code that receives an indication to provide an event notification to a user;
code that determines an attentive state of the user;
code that identifies a positional orientation of an information handling device associated with the product;
code that determines that the event notification cannot be communicated to the user from the information handling device based on the attentive state and the positional orientation; and
code that provides, responsive to the determining, the event notification using another device comprising output capabilities compatible with the attentive state.
